(19) United States
(12) Patent Application Publication
(10) Pub. No.: US 2016/0219835 A1
(43) Pub. Date: Aug. 4, 2016

(54) SIGNAL ACTIVATED PET TREAT DISPENSER AND TOY WITH ACTIVATION COLLAR

(71) Applicant: Bradley Faecher, Sudbury, MA (US)

(72) Inventor: Bradley Faecher, Sudbury, MA (US)

(21) Appl. No.: 14/609,389

(22) Filed: Jan. 29, 2015

(51) Int. Cl. A01K 15/02; A01K 27/00; A01K 5/02

(52) U.S. Cl. CPC A01K 15/025; A01K 5/02; A01K 27/001; A01K 27/009

(57) ABSTRACT

The invention comprises a novel pet treat dispenser system wherein a transmitter on a pet collar communicates with a frequency matched receiver in the treat dispenser and causes inserted treats to fall out of apertures in the dispenser. The dispenser has a plush exterior for visual stimulation and reacts to the electronic signal by wobbling, rolling or both. Gravity causes a few treats to eject from apertures in the dispenser upon activation by the pet's collar transmitter. Activation occurs in short pulses so that the pet must continually engage with the dispenser to receive treats. On board intelligent proximity sensors control distance response modes and also prevent unwanted activation when the pet is not sufficiently near the toy.

### FIELD

The invention relates to a novel pet treat dispenser system wherein a transmitter on a pet collar communicates with a receiver in the treat dispenser and causes inserted treats to eject from apertures in the dispenser. The dispenser is in the form of a hollow receptacle covered with a plush encasement that reacts to an electronic signal by wobbling, rolling or both.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet treat dispenser system wherein a transmitter on a pet collar communicates with a receiver in the treat dispenser and causes inserted treats to fall out of apertures in the dispenser. The dispenser in this main embodiment is in the form of a plush animal that reacts to an electronic signal by wobbling, rolling or both. The signal may be transmitted via RF, IR, Bluetooth, voice command or other common transmission forms.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive toy and treat trainer.

### THE INVENTION SUMMARY, OBJECTS AND ADVANTAGES

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

The inventive treat dispenser addresses the behavioral triggers which will challenge a dog and reward it when the behavior is repeated.

Treats are inserted into a cavity inside the outer plush encasement via a capped insertion point. The user then replaces the cap and treats exit from designed apertures for release when the dispenser moves in reaction to a received signal from the pet's collar transmitter.

When the pet is in proximity to the dispenser the signal emits from the collar and triggers the dispenser to wiggle, roll or both in combination. The transmitter and receiver include intelligent proximity detection, and will cause more frequent or varied reactions as the pet nears the dispenser. Once activated, gravity then allows a few treats to dispense from the scattered apertures in the dispenser. As a radio signal propagates through the air, it experiences a loss in amplitude. If the range between the sender and receiver increases, the signal amplitude declines exponentially. Thus, the intelligent proximity detection will both vary the number of reactions as a pet is nearer the dispenser as well as prevent unwanted reactions when the pet is not sufficiently near the receiver.

Transmit power and receiver sensitivity are designed for optimum range. Obviously a pet owner does not desire the dispenser to be activated from the park while walking the pet so the link budget is designed accordingly. Signals are transmitted in short bursts so that reactions occur in short intervals. This requires the pet to again approach the dispenser to trigger another reaction. Over time, the pet will “learn” that its actions will cause a reaction with the treat dispenser. Also over time, the pet will learn that the proximity to the dispenser will exhibit variations over that of reactions when the pet is several feet from the dispenser.

A further embodiment is the inclusion of a voice activated signal for audio output wherein the voice activation will function in a similar fashion to the other wireless signal modes.

### BRIEF DESCRIPTION OF THE DRAWINGS

The invention is described in further detail by reference to three (3) drawings sufficient in detail to describe the invention in which:

FIG. 1 is an illustration of the dispenser and activation collar;

FIG. 2 is an example of the dispenser having rolled on its side dispensing a few treats; and

FIG. 3 is an internal cutout illustrating the treat cavity and cap.

### DETAILED DESCRIPTION, INCLUDING BEST MODES OF CARRYING OUT THE INVENTION

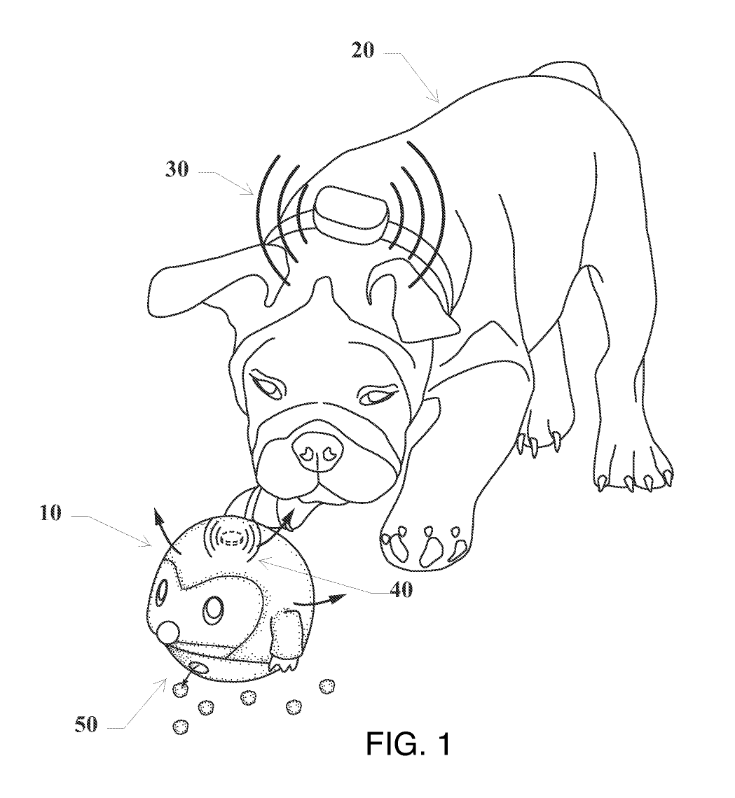

FIG. 1 illustrates the treat dispenser 10 in motion as activated by the dog's 20 transmitter located in the inventive dog collar 30. The receiver 40 located on the dispenser receives a signal and the dispenser rolls, wiggles or a combination of both. The action is random. Apertures 50 are spread out around the dispenser so as to allow treats to be ejected as the dispenser moves in response to the electronic signal from the transmitter 20.

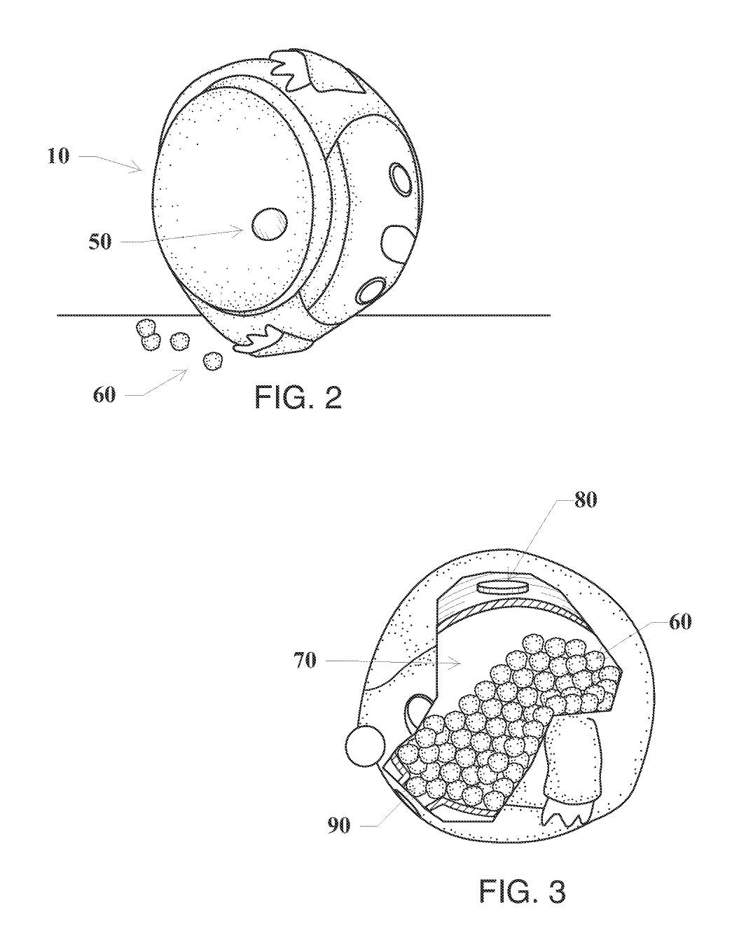

FIG. 2 is a simple depiction of the dispenser 10 as having rolled on its side in response to an electronic signal from the pet's collar. Treats 60 have ejected from one of the apertures 50 so that the pet my consumer them and be ready to trigger another response from the dispenser. The link budget is designed accordingly to maintain a reasonable trigger distance between the pet collar and the dispenser's receiver. Thus, the pet must be in reasonable proximity to the dispenser to trigger activation. The further away the pet is, the lesser or varied the dispenser's reaction. Signals are transmitted in short bursts so that reactions occur in short intervals rather than allow a prolonged emission of treats.

FIG. 3 illustrates a cutout of the treat dispenser's treat receptacle 70. A fill cap 80 may be snapped or screw-on in fashion and allows a user to fill the dispenser with treats 60. A funneled opening 90 controls the flow of treats to be ejected so that only a few treats are released at one time.

1) A wirelessly activated pet treat dispenser and toy with activation collar comprising;
a) a hollow plush dispenser
b) an internal receptacle
c) a fill cap
d) an electronic signal receiver
e) apertures for treat exit
f) a frequency matched pet collar
g) intelligent proximity sensors

2) A wirelessly activated pet treat dispenser and toy with activation collar as in claim 1 wherein the dispenser is hollow and covered in a plush fabric.

3) A wirelessly activated pet treat dispenser and toy with activation collar as in claim 1 wherein the internal receptacle is designed to contain treats and further has a funneled opening for treat ejection.

4) A wirelessly activated pet treat dispenser and toy with activation collar as in claim 1 wherein the internal receptacle has an external fill cap which may screw or snap on to allow for filling the receptacle.

5) A wirelessly activated pet treat dispenser and toy with activation collar as in claim 1 wherein an electronic signal receiver is affixed to the dispenser and where such signal causes the dispenser to roll or wobble or both.

6) A wirelessly activated pet treat dispenser and toy with activation collar as in claim 1 wherein the receptacle and outer encasement both contain apertures for treat ejection upon signal activation and movement of the dispenser toy.

7) A wirelessly activated pet treat dispenser and toy with activation collar as in claim 1 wherein a frequency matched pet collar is required to transmit signals to the receiver in the dispenser.

8) A wirelessly activated pet treat dispenser and toy with activation collar as in claim 1 wherein an intelligent proximity sensor located in the transmitter and receiver provides varying output responses based upon proximity between the two.

9) A wirelessly activated pet treat dispenser and toy with activation collar as in claim 1 wherein signals may include voice activation for audio output or control of signal responses within the receiving treat dispenser and toy.
